(19) United States
(12) Patent Application Publication
(10) Pub. No.: US 2018/0246648 A1
(43) Pub. Date: Aug. 30, 2018

(54) CONTINUOUS DISASTER PROTECTION FOR MIGRATED VOLUMES OF DATA

(71) Applicant: Dell Products L.P., Round Rock, TX (US)

(72) Inventors: Prakash VENKAT, Bangalore (IN); Ryan J. THOMAS, Plymouth, MN (US); G. Paul KONING, New Boston, NH (US); Gaurav Mukul BHATNAGAR, Bangalore (IN)

(73) Assignee: Dell Products L.P., Round Rock, TX (US)

(21) Appl. No.: 15/445,474

(22) Filed: Feb. 28, 2017

(51) Int. Cl. G06F 3/06; G06F 11/14

(52) U.S. Cl. CPC G06F 3/065; G06F 3/0619; G06F 2201/84; G06F 3/067; G06F 11/1451; G06F 3/0647

(57) ABSTRACT

A method and system perform a background copy of a source volume to a migration volume. The source volume has an asynchronous replication relationship with a disaster recovery (DR) volume. A migration volume snapshot may be obtained and host I/O to the source volume may be disabled. A post-copy replication of the source volume is performed to synchronize the source volume and the DR volume. A replication snapshot, comprising a snapshot of the DR volume, is obtained and an identifier of the replication snapshot is modified in accordance with an identifier of the migration snapshot. For example, the identifier of the migration snapshot may be copied to the replication snapshot. Thereafter, an existing replication relationship between the source volume and the DR volume may be disabled and a post-migration replication relationship between the migration volume and the DR volume established such that subsequent replication are incremental or delta replications.

### TECHNICAL FIELD

The present disclosure generally relates to data storage information handling systems, and, more particularly, migration of data among such systems.

### BACKGROUND

As the value and use of information continue to increase, individuals and businesses seek additional ways to process and store information. One option available to users is information handling systems. An information handling system (IHS) generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, an information handling system may include a variety of hardware and software components that may be configured to process, store, and communicate information and may include one or more computer systems, data storage systems, and networking systems.

An information handling system can be configured in several different configurations ranging from a single, stand-alone computer system to a distributed, multi-device computer system, to a networked computer system with remote or cloud storage systems.

Entities that maintain large and frequently accessed storage systems will readily appreciate that, because it is necessary or desirable to migrate data from one or more source storage devices to one or more target storage devices, the ability to migrate data efficiently is important. In at least some data storage environments, an important characteristic of efficient data migration is the extent to which data migration tasks halt, slow, or otherwise disrupt workload input/output (I/O) operations. Data migration that has little or no impact on workload I/O may be referred to as “seamless” data migration.

Selected Acronyms Defined:

SCSI: Small Computer System Interface;

iSCSI: IP-based SCSI;

SAN: Storage Area Network;

PSA: Peer Storage, Peer Storage Array—an iSCSI SAN from EqualLogic (EQL), a subsidiary of Dell, Inc.;

SC: Storage Center—a SAN product from Dell Compellent (CML);

DR: Disaster Recovery, as in DR Volume;

UUID: Universally Unique Identifier

Disaster recovery configuration information is one category of metadata. Customers typically replicate critical data as a standard part of their DR readiness. Generally, a relationship exists between the Source LUN and a remote DR LUN to ensure that the application has access to data, in case of a DR situation. The two most common relationships that exist between Source LUN and DR LUN are synchronous and asynchronous.

Existing DR procedures include procedures enabling applications to bring up the data on the DR LUN following a DR event. During migration of a primary source LUN, the migration volume may be unprotected, i.e., un-replicated, until a new replication relationship is created and the migration volume synced to the DR LUN.

Migration of data encompasses more than the transfer of user data from one storage resource to another. Generally, data storage includes a significant amount of metadata that must be accounted for during migration.

### SUMMARY

Disclosed subject matter addresses challenges associated with maintaining the integrity of a migration volume.

In accordance with disclosed subject matter, disclosed algorithms facilitate continuously protected migration (CPM), including continuously protected heterogeneous migration, in which a source LUN of a first type, e.g. a PSA LUN, is migrated to source LUN of a different type, e.g., a CML LUN. Under disclosed embodiments of CPM, the migration volume is always protected and few, if any, significant changes in existing DR procedures are required.

In accordance with disclosed subject matter, when a source volume is in an asynchronous point-in-time replication relationship with a DR volume of the same storage type and platform, the CPM procedure retains the DR relationship such that, following completion of the migration, a migration volume becomes the I/O source/target of host I/O, but the DR volume remains. Embodiments may employ one or more algorithms or procedures to avoid full-volume replications or transfers.

A data migration method and system management resource perform background copy of a source volume to a migration volume, wherein the source volume is in an asynchronous replication relationship with a disaster recovery (DR) volume. Responsive to detecting a completion of the background copy, a migration snapshot, comprising a snapshot of the migration volume, is obtained and host I/O to the source volume is disabled. A post-copy replication of the source volume is performed to synchronize the source volume and the DR volume. A replication snapshot, comprising a snapshot of the DR volume, is obtained and an identifier of the replication snapshot is modified in accordance with an identifier of the migration snapshot. For example, the identifier of the migration snapshot may be copied to the replication snapshot. Thereafter, an existing replication relationship between the source volume and the DR volume may be disabled and a post-migration replication relationship between the migration volume and the DR volume established.

The source volume and the DR volume may be associated with the same type of storage resource or platform and the source volume and the migration volume may be associated with different types of storage resources. The source volume may be associated with a peer storage array storage resource and the migration volume may be associated with a storage center storage resource. Modifying the identifier of the replication snapshot may include obtaining an identifier of the migration snapshot and copying the identifier to the replication snapshot. A replication schedule of the source volume may be disabled before performing the post-copy replication. Before performing the post copy replication, the system may pause to permit active replication operations to complete. During a subsequent replication, synchronizing the migration volume with the DR volume, wherein the synchronizing comprises an incremental synchronization or replication corresponding to a difference between a current snapshot of the migration volume and a most recent snapshot of the migration volume. A management relationship may be established as part of the process so that the source volume, the DR volume, the migration volume, and a host system are all in a common management domain.

The above summary is not intended as a comprehensive description of the claimed subject matter but, rather, is intended to provide an overview of the applicable subject matter. Other methods, systems, software, functionality, features and advantages of the claimed subject matter will be or will become apparent to one with skill in the art upon examination of the following FIGUREs and detailed written description.

### BRIEF DESCRIPTION OF THE DRAWINGS

FIG. 1A through FIG. 1E illustrate an information handling system and storage platform at various points in time during a seamless data migration process of a replicated volume; and

FIG. 2 illustrates a flow diagram of a seamless data migration process.

### DETAILED DESCRIPTION

In the following detailed description, specific exemplary embodiments in which disclosed subject matter may be practiced are described in sufficient detail to enable those skilled in the art to practice the disclosed embodiments. For example, details such as specific method orders, structures, elements, and connections have been presented herein. However, it is to be understood that the specific details presented need not be utilized to practice embodiments of disclosed subject matter. It is also to be understood that other embodiments may be utilized and that logical, architectural, programmatic, mechanical, electrical and other changes may be made within the scope of the disclosed subject matter. The following detailed description is, therefore, not to be taken as limiting the scope of the appended claims and equivalents thereof.

References within the specification to “one embodiment,” “an embodiment,” “at least one embodiment”, or “some embodiments” and the like indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features may be described which may be exhibited by some embodiments and not by others. Similarly, various requirements may be described which may be requirements for some embodiments but not for other embodiments.

It is understood that the use of specific component, device, and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different elements, features, protocols, or concept names are utilized. Thus, each term utilized herein is to be given its broadest interpretation given the context in which that term is utilized.

Generally, disclosed embodiments perform seamless migration of a volume that is in an asynchronous replication relationship with a disaster recovery volume by establishing transition each of the three volumes to a synchronous data state in which all three volumes have identical data before terminating the existing replication relationship and establishing a post-migration replication relationship between the migration volume and the disaster recovery volume.

Father the replication relationship between the migration volume and the disaster recovery volume is established, the replication relationship between the migration volume and the disaster recovery volume is configured wherein the migration volume is incrementally replicated from migration volume to disaster recovery volume.

Although embodiments are described herein with respect to a migration/replication example in which a Peer Storage Array (PSA) volume, which is replicated on a PSA disaster recover volume, is migrated to a Compellent (CML) volume, disclosed concepts encompass migration/replication involving any two or more storage arrays that support point-in-time replication relationships.

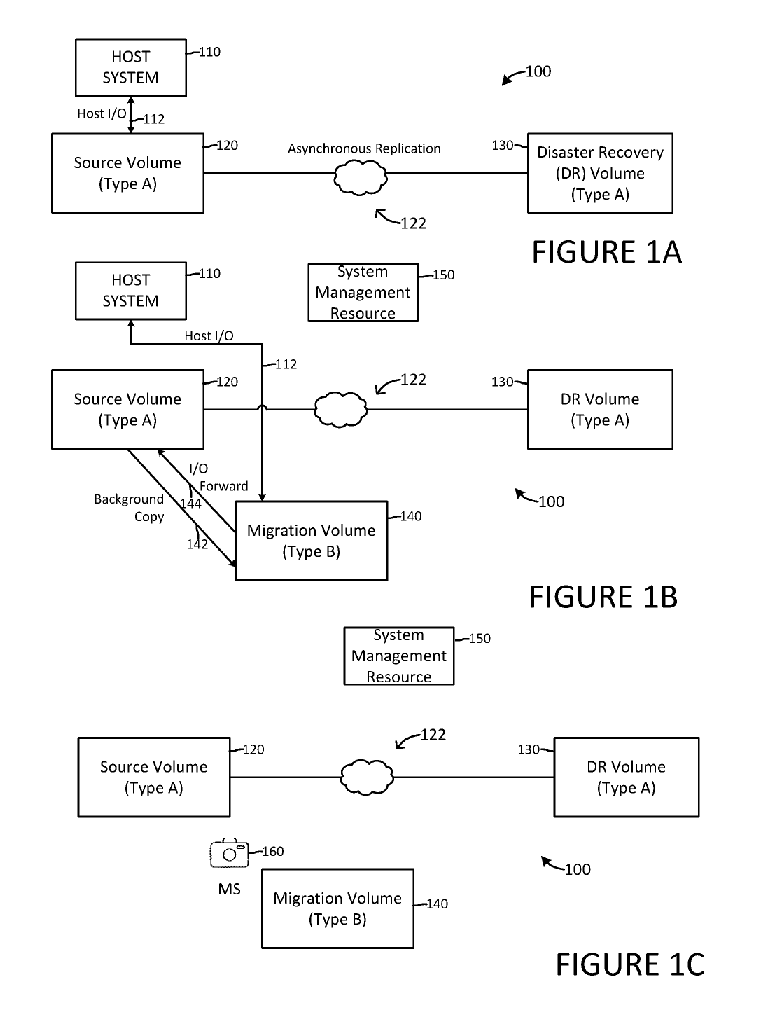

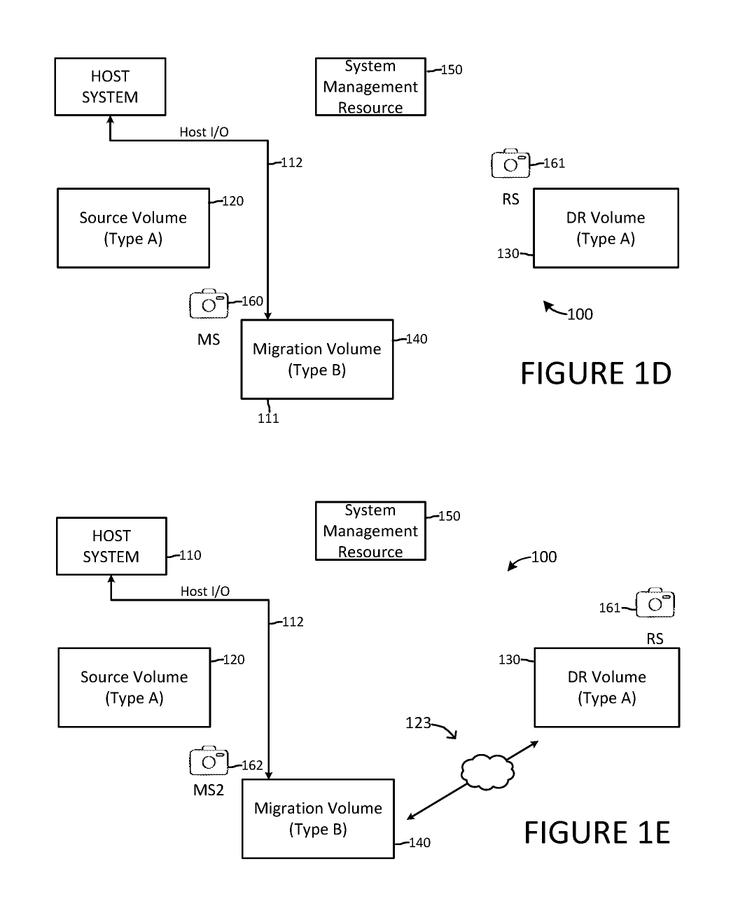

Turning now to the drawings, FIG. 1A illustrates a storage platform 100 in accordance with disclosed subject for seamlessly performing a cross-platform migration of a source volume that is in an asynchronous replication relationship with a disaster recover volume. The storage platform 100 illustrated in FIG. 1A includes a host system 110 providing workload I/O, referred to herein as host I/O 112, to a storage volume identified as original source volume 120 or, more simply, original volume 120. Original source volume 120 is illustrated in an existing asynchronous replication relationship 122 with a disaster recovery volume 130.

At some unspecified point in time, a manual or automated decision may be made by an administrator or other user or resource, to migrate original volume 210 to a different volume referred to herein as the migration volume 140. In at least some instances, the migration volume 140 is from a different storage platform than the original volume 120. In one particular implementation, the original volume 120 is a PSA volume and migration volume 140 is a CML volume.

FIG. 1B illustrates a system management resource 150 that may initiate, monitor, management, and/or control one or more aspects and operations of the illustrated migration process. Although not explicitly indicated in FIG. 1B for the sake of maintain clarity and focus upon the migration process, system management resource 150 may communicate with management resource endpoints of host system 110, original volume 120, migration volume 140, and disaster recovery volume 130. In such embodiments, host system 110, original volume 120, migration volume 140, and disaster recovery volume 130 may include within a management domain of system management resource 150. In such embodiments, system resource management may have established and secure and trusted communication with any one or more of the illustrated storage volumes.

As part of the migration initiated in FIG. 1A, the storage platform 100 illustrated in FIG. 1B has established migration volume 140 as the target volume for host I/O operations 112. In addition, system management resource 150 has initiated a cross-platform background operation, referred to herein as the background copy operation 144, that copies the contents of original volume 120 to migration volume 140 as a background process than enables the migration volume to continue to receive host I/O 112. In at least one embodiment, storage platform 100 and/or one or more of the storage volumes requires dual confirmations of host I/O operations 112 while the background copy 142 is in progress. In such embodiments, host 110 requires a first confirmation, from migration volume 140 and a second confirmation from original volume 120 of each host I/O operation 112 initiated while background copy 142 is in progress.

FIG. 1C illustrates a point in time when background copy operation 142 has just completed. In the storage platform 100 illustrated in FIG. 1C, system management resource 150 or some other resource may freeze host I/O operations 112 momentarily before taking a volume snapshot, identified in FIG. 1C as migration snapshot (MS) 160 of the point in time contents of migration volume 140. At this time, the I/O forwarding link 144 from migration volume 140 to original volume 120 is terminated so that, when host I/O operations 112 resume, host I/O operations target migration volume 140 only and the host system 110 does not require or seek confirmation of host I/O operations from original volume 120.

The data contents resulting in MS 160 are identical to the contents of original volume 120 since host I/O to source volume 120 is halted upon completion of the background copy 144. In addition, the original volume 120 will also be disabled following completion of the migration to prevent/reject any accidental writes.

With the migration from original volume 120 to migration volume 140 complete, the system management resource 150 may prompt an administrator or other user to indicate whether the existing DR configuration. FIGS. 1D through 1F illustrate operations performed when the administrator or other user has the option to retain the existing DR configuration has said YES to this option.

In FIG. 1D, following the creation of MS 160, host I/O operations 112 resume to migration volume 140 as illustrated in FIG. 1D. System management resource 150, upon detecting completion of the background copy, it determines whether any previously initiated replication operations between original volume 120 and DR volume 130 remain “in flight” and, if so, waits until active replication between original volume 120 and DR volume 130 completes. Upon confirming completion of all inflight replication operations, system management resource 150 may terminate or disable any and all replication schedules associated with original volume 120, thereby terminating any and all future replication events between original volume 120 and DR volume 130.

In at least one embodiment, the system management resource 150 may then initiate a final replication of original volume 120 and await the completion of this final replication. Because replication may have been ongoing on a scheduled basis prior to the migration request, the final replication request initiated by system management resource 150 may complete relatively quickly. At this point in time, the contents of the DR volume 130 are captured in a snapshot referred to herein as replication snapshot (RS) 161. When the final replication completes, the contents of DR volume 130 are identical to the contents of original volume 120, which are both identical to the contents that produced MS 160. Accordingly, the MS 160 is identical to the RS 161 and system management resource 150 may disable or otherwise terminate the replication relationship 122 between original volume 120 and PR volume 130. In at least one embodiment, system management resource 150 may then read an universally unique identifier (UUID) from MS 160 on migration volume 140 and copy the UUID to RS 161. The UUID may correspond to one of two or more UUIDs that may be used with certain storage platforms.

Referring now to FIG. 1E, a new asynchronous replication relationship, indicated in FIG. 1E as asynchronous replication relationship 123, is established between migration volume 140 and DR volume 130. In some embodiments, the creation of the replication relationship may persist such that it need only be executed once for a given pair of sites and need not be duplicated for every volume at those one or more sites. The system management resource 150 may update the DR configuration information to reflect migration volume 140 is now the source of data for the asynchronous replication relationship 123.

The system management resource 150 may then take a new snapshot of migration volume 130, identified as MS2 162 in FIG. 1E. MS2 162 captures all changes in migration volume 140 since MS 160 was taken. In at least one embodiment, the creation of MS2 162 will kick off a point-in-time replication from migration volume 140 to DR volume 130. Since the original UUID of RS 161 is same as the UUID of MS2 162, only the incremental change since MS 160 was taken will be replicated to DR volume 130. System management resource 150 may then import the previously existing replication schedule for original volume 120 and apply the same schedule to the new, replication, which may be a cross platform replication in embodiments that employ a Type A DR volume 130 and a Type B migration volume 140. In the event of any conflict applying the original volume schedules on the migration volume 140, the administrator or other user may be given an option to modify the schedule to ensure that migration volume 130 continues to be protected after migration.

It will be noted and appreciated that, during the entire process described above with respect to FIG. 1A through 1E, host operations 112 are suspended at only one point in time and, even then, only suspended for enough time to create the migration snapshot 160.

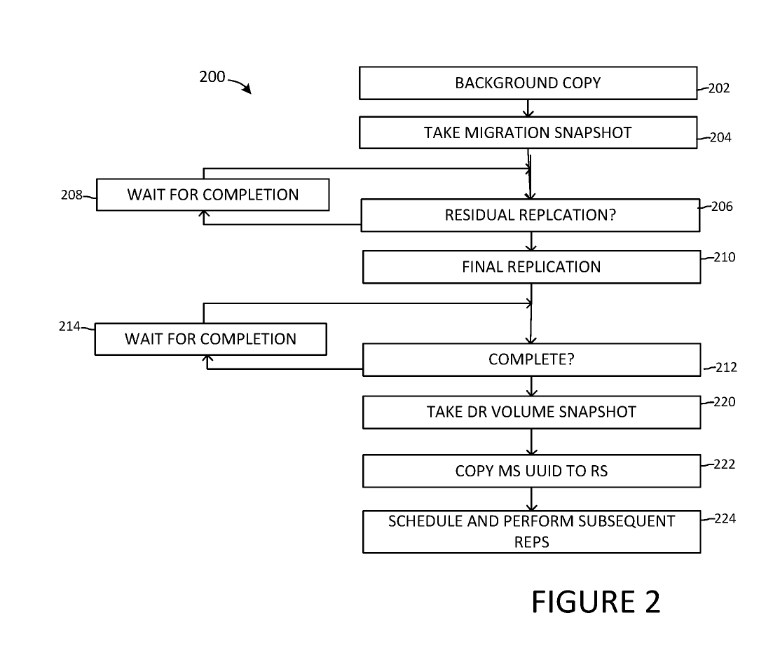

FIG. 2 illustrates a flow diagram of a method 200 for seamless migration in accordance with the migration described above with respect to FIG. 1A through 1E. As depicted in FIG. 2, method 200 begins when a background copy 202 is initiated following a request or determination to migrate a source volume that is in an asynchronous replication relationship with a DR volume. The background copy 202 copies the content of original volume 120 to migration volume 140 as a background process while host I/O continues, with I/O forwarding in at least some embodiments, as described above. Upon completion of the background copy, a snapshot of the migration volume is taken at block 204 and the I/O forwarding to source volume 120 terminates. A pause (blocks 206 and 208) occurs to permit completion of an in-flight replication operations between original volume 120 and DR volume 130. A final replication (block 210) of source volume 120 is performed to place DR volume in the same data state as the MS snapshot 160 and in the same data state as the original volume 120. The system management resource may again wait (blocks 212, 214) for completion of the final replication before taking (block 220) a replication snapshot and copying (block 222) the UUID from the migration snapshot into the replication snapshot so that, thereafter, migration snapshots are recognized by the DR volume and subsequent replications may be scheduled and executed (block 224) to perform incremental replications of migration volume 140.

In the described manner, an existing replication relationship is protected during migration and available post migration to reduce the window of disaster exposure. In at least some embodiments, much if not all of the DR configuration and activation may remain unchanged throughout the process, including post-migration, all without requiring a complete replication at any point in the process. Instead, the incremental replication that existed with the original volume and the DR volume is persisted after migration to the migration volume.

Any one or more processes or methods described above, including processes and methods associated with any figures illustrating flow diagrams, may be embodied as a computer readable storage medium or, more simply, a computer readable medium including processor-executable program instructions, also referred to as program code or software, that, when executed by the processor, cause the processor to perform or otherwise result in the performance of the applicable operations.

A computer readable medium, which may also be referred to as computer readable memory or computer readable storage, encompasses volatile and non-volatile media, memory, and storage, whether programmable or not, whether randomly accessible or not, and whether implemented in a semiconductor, ferro-magnetic, optical, organic, or other suitable medium. IHSs may include two or more different types of computer readable medium and, in such systems, program code may be stored, in whole or in part, in two or more different types of computer readable medium.

Unless indicated otherwise, operational elements of illustrated or described methods may be combined, performed simultaneously, or performed in a different order than illustrated or described. In this regard, use of the terms first, second, etc. does not necessarily denote any order, importance, or preference, but may instead merely distinguish two or more distinct elements.

Program code for effecting described operations may be written in any appropriate combination of programming languages and encompasses human readable program code including source code as well as machine readable code including object code. Program code may be executed by a general purpose processor, a special purpose processor, including, as non-limiting examples, a graphics processor, a service processor, or an embedded processor or controller.

Disclosed subject matter may be implemented in any appropriate combination of software, firmware, and hardware. Terms including circuit(s), chip(s), processor(s), device(s), computer(s), desktop(s), laptop(s), system(s), and network(s) suggest at least some hardware or structural element(s), but may encompass non-transient intangible elements including program instruction(s) and one or more data structures including one or more databases.

While the disclosure has been described with reference to exemplary embodiments, it will be understood by those skilled in the art that the disclosure encompasses various changes and equivalents substituted for elements. Therefore, the disclosure is not limited to the particular embodiments expressly disclosed, but encompasses all embodiments falling within the scope of the appended claims.

As used herein, the singular forms “a”, “an” and “the” are intended to include the plural forms as well, unless the context clearly indicates otherwise. It will be further understood that the terms “comprises” and/or “comprising,” when used in this specification indicate the presence of stated features, operations, elements, and/or components, but does not preclude the presence or addition of one or more other features, operations, elements, components, and/or groups thereof.

What is claimed is:

1. A data migration method comprising:
performing a background copy of a source volume to a migration volume, wherein the source volume is in a replication relationship with a disaster recovery (DR) volume;
responsive to detecting a completion of the background copy, obtaining a migration snapshot, comprising a snapshot of the migration volume, and disabling host I/O to the source volume;
performing a post-copy replication of the source volume to synchronize the source volume and the DR volume;
obtaining a replication snapshot, comprising a snapshot of the DR volume and modifying an identifier of the replication snapshot in accordance with an identifier of the migration snapshot;
disabling an existing replication relationship between the source volume and the DR volume; and
establishing a post-migration replication relationship between the migration volume and the DR volume, wherein the

2. The method of claim 1, wherein the source volume and the DR volume are associated with the same type of storage resource.

3. The method of claim 1, wherein the source volume and the migration volume are associated with different types of storage resources.

4. The method of claim 3, wherein the source volume is associated with a peer storage array storage resource and the migration volume is associated with a storage center storage resource.

5. The method of claim 1, wherein modifying the identifier of the replication snapshot includes obtaining an identifier of the migration snapshot and copying the identifier to the replication snapshot.

6. The method of claim 1, further comprising:
disabling a replication schedule of the source volume before performing the post-copy replication.

7. The method of claim 1, further comprising, before performing the post copy replication, pausing to permit active replication operations to complete.

8. The method of claim 1, further comprising, during a subsequent replication, synchronizing the migration volume with the DR volume, wherein said synchronizing comprises copying data corresponding to a difference between a current snapshot of the migration volume and a most recent snapshot of the migration volume.

9. The method of claim 1, further comprising establishing a management relationship with the source volume, the DR volume, the migration volume, and a host system.

10. An information handling system, comprising:
a processor; and
computer readable medium including processor executable instructions that, when performed by a processor, cause the processor to perform operations comprising:
performing a background copy of a source volume to a migration volume, wherein the source volume is in a replication relationship with a disaster recovery (DR) volume;
responsive to detecting a completion of the background copy, obtaining a migration snapshot, comprising a snapshot of the migration volume, and disabling host I/O to the source volume;
performing a post-copy replication of the source volume to synchronize the source volume and the DR volume;
obtaining a replication snapshot, comprising a snapshot of the DR volume and modifying an identifier of the replication snapshot in accordance with an identifier of the migration snapshot;
disabling an existing replication relationship between the source volume and the DR volume; and
establishing a post-migration replication relationship between the migration volume and the DR volume, wherein the.

11. The information handling system of claim 10, wherein the source volume and the DR volume are associated with the same type of storage resource.

12. The information handling system of claim 10, wherein the source volume and the migration volume are associated with different types of storage resources.

13. The information handling system of claim 12, wherein the source volume is associated with a peer storage array storage resource and the migration volume is associated with a storage center storage resource.

14. The information handling system of claim 10, wherein establishing a replication relationship includes obtaining an identifier of the migration snapshot and assigning the identifier to the replication snapshot.

15. The information handling system of claim 10, further comprising:
disabling a replication schedule of the source volume before performing the post-copy replication.

16. The information handling system of claim 10, further comprising, before performing the post copy replication, pausing to permit active replication operations to complete.

17. The information handling system of claim 10, further comprising, during a subsequent replication, synchronizing the migration volume with the DR volume, wherein said synchronizing comprises copying data corresponding to a difference between a current snapshot of the migration volume and a most recent snapshot of the migration volume.

18. The information handling system of claim 10, further comprising establishing a management relationship with the source volume, the DR volume, the migration volume, and a host system.
